(19) United States
(12) Patent Application Publication
(10) Pub. No.: US 2009/0035059 A1
(43) Pub. Date: Feb. 5, 2009

(54) W-BEAM ROAD BARRIER

(76) Inventor: Gidi Kohali, Hod Hasharon (IL)

Correspondence Address: David Klein;DEKEL PATENT LTD., Beit HaRof'im, 18 Menuha VeNahala Street, Room 27, REHOVOT, IL

(21) Appl. No.: 11/833,253

(22) Filed: Aug. 3, 2007

(51) Int. Cl. E01F 13/00; G02B 5/12

(52) U.S. Cl. 404/6; 359/515

(57) ABSTRACT

A W-beam road barrier including a barrier having a W-shaped cross section defining two or more crests and one or more troughs between the crests, with a light reflecting element affixed to the trough or a rear surface of at least one of the crests.

### FIELD OF THE INVENTION

The present invention relates generally to road barriers, and more particularly to a W-beam road barrier with light reflecting elements added thereto.

### BACKGROUND OF THE INVENTION

Various road barriers exist for preventing vehicles from crashing into other vehicles or for demarcating oppositely directed traffic lanes. One such road barrier is called a W-beam road barrier from its W-shaped cross section.

The W-beam barrier shape became the standard in the USA in the 1950's and was first introduced into New Zealand in the early 1960's, being imported through Fletcher Steel. CSP Pacific manufactures the FLEXRAIL W-beam and it is the most common roadside crash barrier in use in New Zealand today.

FLEXRAIL is roll-formed from coil steel and sheared to length. It is then punched, slotted and hot-dip galvanized in accordance with AS/NZS 3845. FLEXRAIL is available in standard effective lengths of 3.81 meters and 1.905 meters for highway rail and 4.00 meters and 2.00 meters for bridge rail.

### SUMMARY OF THE INVENTION

The present invention seeks to provide a W-beam road barrier with light reflecting elements added thereto, as is described more in detail hereinbelow.

There is provided in accordance with an embodiment of the present invention a W-beam road barrier including a barrier having a W-shaped cross section defining two or more crests and one or more troughs between the crests, with a light reflecting element affixed to the trough or a rear surface of at least one of the crests.

In accordance with an embodiment of the present invention the light reflecting element may include light reflecting tape. Alternatively or additionally, the light reflecting element may include a light-reflecting elastomeric strip.

The light reflecting element may include a luminescent rubber. The light reflecting element may include a phosphorescent rubber.

The light reflecting element may be single-colored or multi-colored.

### BRIEF DESCRIPTION OF THE DRAWINGS

The present invention will be understood and appreciated more fully from the following detailed description taken in conjunction with the drawings in which:

FIGS. 1 and 2 are simplified pictorial and cross-sectional illustrations, respectively, of a W-beam road barrier, constructed and operative in accordance with an embodiment of the present invention.

### DETAILED DESCRIPTION OF EMBODIMENTS

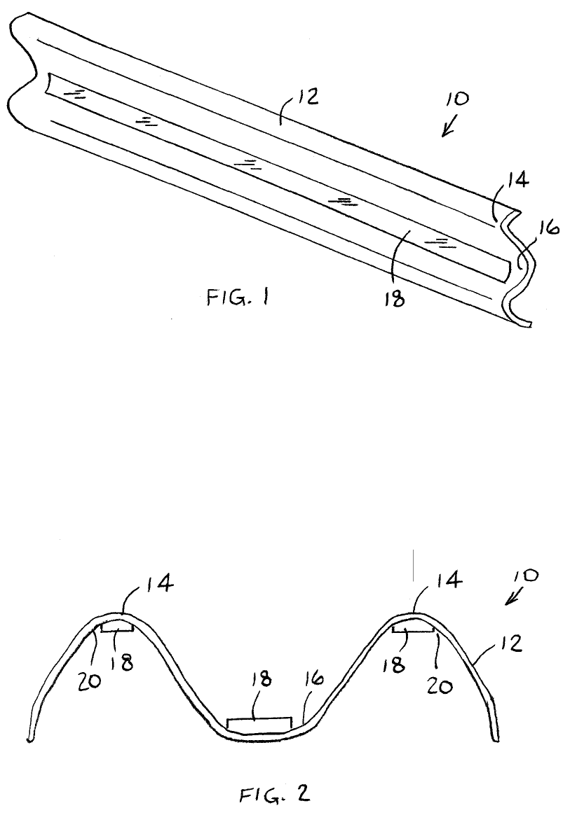

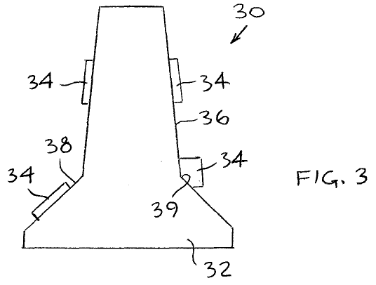

Reference is now made to FIGS. 1 and 2, which illustrate a W-beam road barrier 10, constructed and operative in accordance with an embodiment of the present invention. The invention may be used in many road applications, such as but not limited to, preventing vehicles from crashing into other vehicles, demarcating oppositely directed traffic lanes, and many others.

The road barrier 10 may include a barrier 12 constructed of a sturdy durable material, such as but not limited to, coil steel which is sheared or otherwise cut to length. The barrier 12 may have a W-shaped cross section defining two crests 14 and a trough 16 between crests 14. A light reflecting element 18 is affixed to the barrier 12, either in trough 16 and/or a rear surface 20 of one or more of crests 14.

For example, the light reflecting element 18 may include light reflecting tape. Suitable examples are visibility/identification tape products designed for enhanced nighttime brightness, such as 3M SCOTCHLITE brand reflective tape, available in different colors, e.g., silver and red.

Another example is a light-reflecting elastomeric strip, such as luminescent rubber or phosphorescent rubber. The light reflecting element may be single-colored or multi-colored.

The light reflecting element 18 may me attached to barrier 12 by any suitable method, such as but not limited to, adhesive, screws, rivets, cord, etc.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

1. A W-beam road barrier comprising:
a barrier having a W-shaped cross section defining at least two crests and at least one trough between the crests, with a light reflecting element affixed to a rear surface of at least one of said crests.

2. The W-beam road barrier according to claim 1, wherein said light reflecting element comprises light reflecting tape.

3. The W-beam road barrier according to claim 1, wherein said light reflecting element comprises a light-reflecting elastomeric strip.

4. The W-beam road barrier according to claim 1, wherein said light reflecting element comprises a luminescent rubber.

5. The W-beam road barrier according to claim 1, wherein said light reflecting element comprises a phosphorescent rubber.

6. The W-beam road barrier according to claim 1, wherein said light reflecting element is single-colored.

7. The W-beam road barrier according to claim 1, wherein said light reflecting element is multi-colored.

8. The W-beam road barrier according to claim 1, comprising two light reflecting elements affixed to rear surfaces of two said crests.
